(19) United States
(12) Patent Application Publication
(10) Pub. No.: US 2020/0152099 A1
(43) Pub. Date: May 14, 2020

(54) Inflation Assembly With Replaceable Outer Wrap

(71) Applicant: Made U Look Promotions, Glastonbury, CT (US)

(72) Inventor: Michael R. Dupuis, Glastonbury, CT (US)

(21) Appl. No.: 16/682,222

(22) Filed: Nov. 13, 2019

Related U.S. Application Data
(60) Provisional application No. 62/767,204, filed on Nov. 14, 2018.

(51) Int. Cl. G09F 21/06

(52) U.S. Cl. CPC G09F 21/06

(57) ABSTRACT

Disclosed herein is a display assembly having a hollow support member and a removable covering. The hollow support member includes a substantially spherical shape having a top end, a bottom end, and a central portion between the top end and the bottom end. The top end includes an attachment portion. The removable covering includes a first end and an opening opposite the first end. The removable covering is configured to have a corresponding spherical shape when fitted over the hollow support member. The opening is configured to be aligned with the top end of the hollow support member such that the attachment portion is accessible. The removable covering includes a plurality of first panels. The removable covering comprises a graphic or message extending across the plurality of first panels.

### CROSS REFERENCE TO RELATED APPLICATION

This application claims priority under 35 U.S.C. § 119(e) to U.S. provisional patent application No. 62/767,204, filed Nov. 14, 2018 which is hereby incorporated by reference in its entirety.

### BACKGROUND

The disclosed embodiments relate to an inflatable assembly, and in particular an inflatable assembly with an inner inflatable support and a separate outer wrap, and even more particularly an inflatable inner member with an outer wrap that can be removed and reused.

Inflatable assemblies exist and are commonly used for decorating and/or advertising. For example, groups of helium filled balloons made from rubber, latex, foil or Mylar (a polyethylene terephthalate) are common in all relevant settings, such as for example, a social gathering or a place of business. For a variety of reasons, including cost and environmental considerations, there has been an increase in non-helium filled inflatables. These assemblies are typically maintained from above (i.e., hanging from a ceiling) rather than floating and securing from below. The advancement of non-helium filled inflatables has serendipitously allowed use of reusable inflatable units made from stronger and heavier materials as compared to helium filled balloons. These non-helium filled units are made from polymeric materials, similar in design to a beach ball or other inflatable ball. The stronger material would be too heavy to float even if filled with helium, so they are secured by any known means from above with the visual effect looking as though they are floating.

Currently, Mylar or foil balloons are the only commonly known balloon that can be printed with a variety of colors, patterns and graphics. They are made from two opposing like-shaped flat faces joined together around a peripheral seam. When inflated, Mylar or foil balloons do not take on a fully rounded shape due to the peripheral seam between two like-shaped panels. They are also typically single-use balloons. Currently, the only known methods to include graphics or another written communication on the outside of a reusable inflatable unit and/or inflatable with a fully round shape creates a permanent printed graphic on the inflatable vessel, such as a screen print. These methods carry drawbacks in that only a single color can be printed at a time and the graphic is permanent. Thus, an inflatable support, even if made from a reusable material which can be inflated to a fully round shape, can only have a single message or graphic printed on it and realistically the message or graphic will only be printed in a single color.

There is thus a need for a new assembly and method that allows inflatable units to be reused with a variety of different messages, graphics and communications, and which include a substantially improved graphic and color selection.

### SUMMARY

In accordance with one aspect of the present disclosure, a display assembly is disclosed. The display assembly includes a hollow support member and a removable covering. The hollow support member includes a substantially spherical shape having a top end, a bottom end, and a central portion between the top end and the bottom end. The top end includes an attachment portion. The removable covering includes a first end and an opening opposite the first end. The removable covering is configured to have a corresponding spherical shape when fitted over the hollow support member. The opening is configured to be aligned with the top end of the hollow support member such that the attachment portion is accessible. The removable covering includes a plurality of first panels. The removable covering comprises a graphic or message extending across the plurality of first panels.

In accordance with another aspect of the present disclosure, a display assembly is disclosed. The display assembly includes a hollow support member and a removable covering. The hollow support member includes a top spherical cap, a bottom spherical cap, and a central spherical segment between the top spherical cap and the bottom spherical cap. The removable covering includes a closed end and an opening opposite the closed end. The opening is configured to be aligned with the top spherical cap of the hollow support member. The removable covering is configured to be fitted over the hollow support member such that the closed end follows a spherical profile shape of the bottom spherical cap of the hollow support member. The removable covering includes a plurality of first panels. The removable covering includes a graphic or message extending across the plurality of first panels.

In accordance with another aspect of the present disclosure, a method is disclosed. A hollow support member is provided. The hollow support member includes a substantially spherical shape having a top end, a bottom end, and a central portion between the top end and the bottom end. The top end includes an attachment portion. A first removable covering is provided. The first removable covering includes a closed end and an opening opposite the closed end. The first removable covering includes a plurality of panels. The first removable covering includes a graphic or message extending across the plurality of panels. The first removable covering is fitted over the hollow support member. The first removable covering is configured to have a corresponding spherical shape when fitted over the hollow support member. The opening is aligned with the top end of the hollow support member such that the attachment portion is accessible.

### BRIEF DESCRIPTION OF THE DRAWINGS

Aspects of the preferred embodiment will be described in reference to the drawings, where like numerals reflect like elements:

FIG. 1 is a perspective view of an embodiment of the disclosed display assembly;

FIG. 2 is a perspective view of a removable covering used in the display assembly shown in FIG. 1;

FIG. 3 is an enlarged view of a top portion of the display assembly shown in FIG. 1;

FIG. 4 is another enlarged view of a top portion of the display assembly shown in FIG. 1;

FIG. 5 is another perspective view of the display assembly shown in FIG. 1;

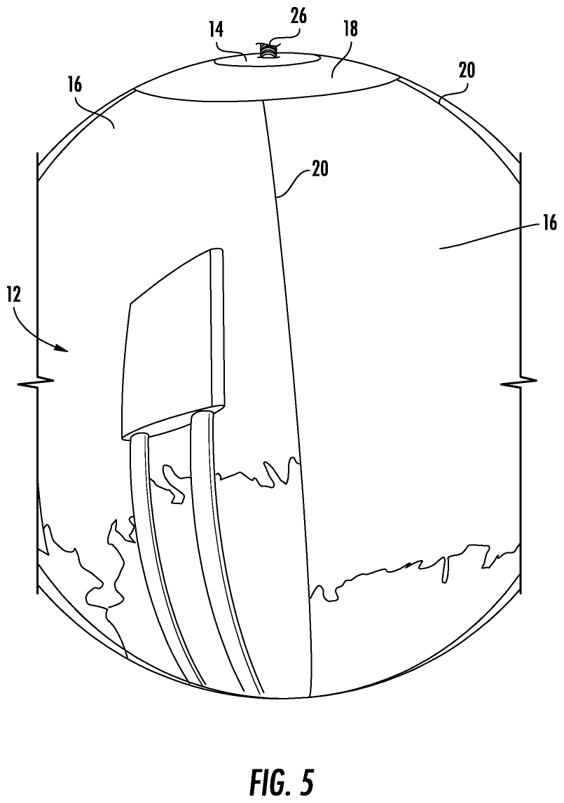

FIG. 6 is another perspective view of the display assembly shown in FIG. 1;

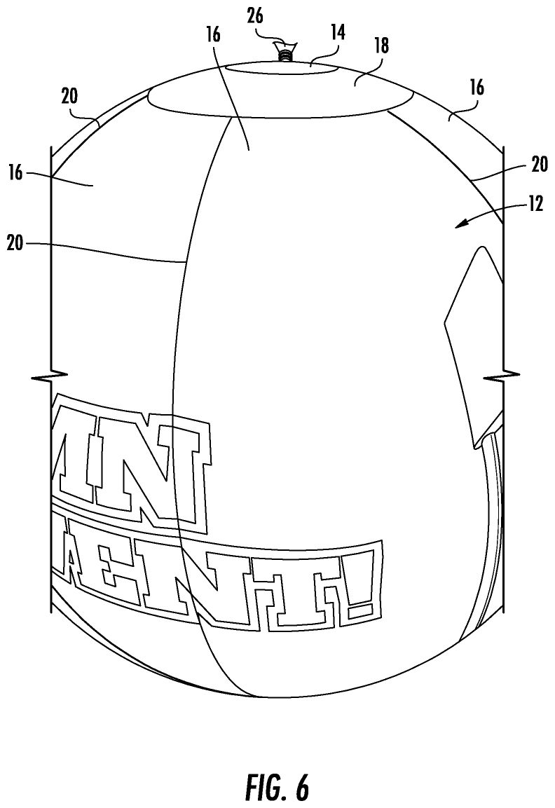

FIG. 7 is a front view of a support member of used in the display assembly shown in FIG. 1;

FIG. 8 is an alternate embodiment of the support member shown in FIG. 7;

FIG. 9 is an alternate embodiment of the display assembly shown in FIG. 1;

FIG. 10 shows the display assembly coupled to a pole; and

FIGS. 11 and 12 illustrate perspective views of alternate embodiments of a plug used in the display assembly shown in FIG. 1.

### DETAILED DESCRIPTION

With reference to the Figures wherein like numerals identify like elements throughout, a preferred embodiment of an inflatable assembly 10 with a reusable covering 12 and inflatable support 14 is disclosed. The covering 12 is formed from a plurality of individual panels 16 joined to one another at a seam 20. The covering also includes an upper panel 18 with an access opening 22. In this embodiment, each panel 16 is joined to adjacent panels 16 permanently a seam 20 via stitching and can optionally include an adhesive to further secure the seam. An additional embodiment exists wherein one or more seams 20 are openable by being formed from a zipper, pile and loop or hook and loop (i.e., Velcro) or similar component that allows the seam 20 to be opened and the adjacent panels detached from one another for access to the interior of the covering 12.

As noted above, a central inflatable support 14 is positioned on the interior of the covering 12. The inflatable support 14 is typically a polymeric material, but may be made from any known material appropriate to hold a gas, such as air, for a long duration. The inflatable support 14 has a fill hole 24. A removable plug, like that shown as reference numeral 26 is used to close the fill hole after inflation. Other embodiments exist with a plug that is formed as part of the inflatable support 14 (similar to an integral plug on a beach ball or inflatable raft).

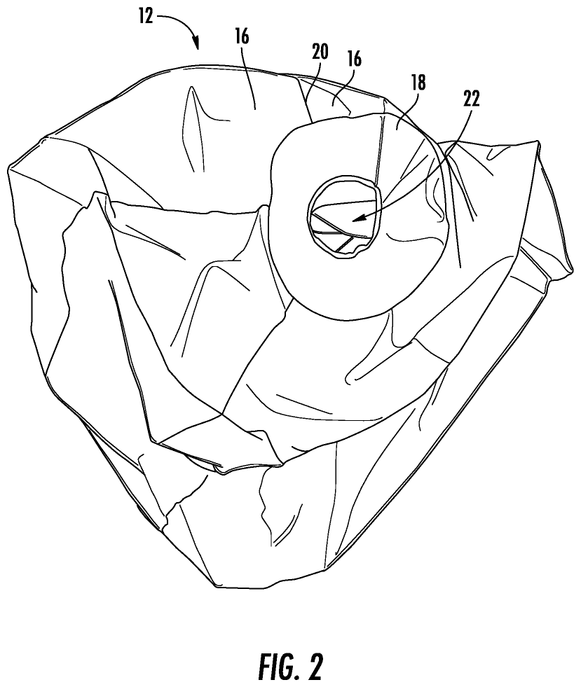

FIG. 2 shows an example of a covering 12 without an inflatable support. As can be seen, the inflatable support 12 is made of a collapsible fabric with multiple panels 16 and 18 joined together at respective seams.

In a typical fill operation, a deflated inflatable support 14 is placed on the interior of the covering 12 through the access opening 22. The inflatable support 14 can be filled via its fill hole 24 with gas such as air (from a pump or similar) accessible from the access opening 22. The covering 12 is typically made from a strong fabric optionally with elastic properties and will stretch slightly as the inflatable support 14 is filled. Once the inflatable support 14 is filled with the appropriate volume of gas, the plug 26 is inserted in the fill hole 24, yielding the assembly as shown in the Figures as reference numeral 10. Advantageously, the fill hole 24 and plug 26 are aligned with the access opening 22.

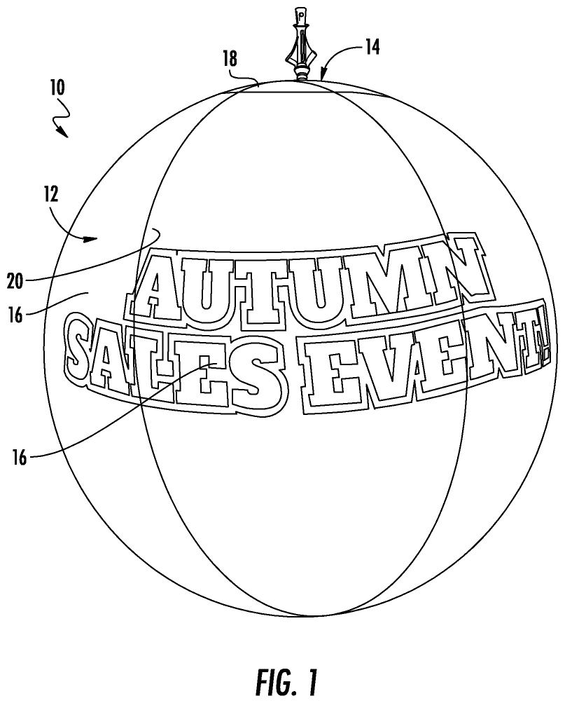

According to some embodiments, the covering 12 is made from a knitted polyester material. Other strong fabric materials may be appropriate, such as knitted nylon, hybrid knit or fabric and optionally a material that has elastic properties. In some other embodiments, the removable covering is made from a synthetic that comprises a minimum of 85% polyurethane polymer, such as Lycra spandex, or Elastane. Having a strong material and/or material with mild stretchable properties can provide several advantages. First, during manufacturing of the covering 12, the having strong panels that can be somewhat stretchable or capable of being tightly pulled significantly improve effectiveness in aligning adjacent panels with one another at a seam. This alignment is especially important wherein the covering 12 includes a large graphic that extends over multiple panels, such as that shown in FIG. 1. Additionally, the strong, tight and optionally elastic properties allow a more robust and even spherical shaped assembly 10 with the covering 12 clinging tightly to the inflatable support 14 when inflated.

In use, one reusable covering 12 with a desired graphic and/or message can be used with a reusable inflatable support for a duration of time. Once a different message or graphic is desired, the assembly 10 can be disassembled via deflation and subsequent removal of the inflatable support 14 from the interior of the covering 12. The covering can be saved and reused at a later time. Similarly, the inflatable support 14 can be used with a new covering 12 with a different message or graphic. The described assembly 10 is particularly well-suited for use as advertising in a business, such as, for example a car dealership. For example, the display assembly 10 with the covering 12 shown in FIG. 1 with detailed graphics and message “AUTUMN SALES EVENT” can be displayed in a sales office via hanging from above for a period of time until the organizers determine that it would like a different graphic and/or message. At that time, the covering 12 can be changed out as described above and replaced with a new covering. In this manner, a single inflatable support 14 can be used to display an infinite number of different graphics, message and advertisements, as opposed to prior art. Since the fabric making up the covering 12 can be digitally printed, the quality of the images and text displayed is dramatically improved from known techniques, in addition to allowing an infinite number of colors and shades.

As also discussed above, embodiments of the assembly exist with a covering that includes a zipper or similar openable and detachable “seam” between at least one pair of adjacent panels 16. This configuration allows removal and attachment of a cover 12 with the inflatable support remaining inflated, rather than requiring deflation and removal through the access opening 22.

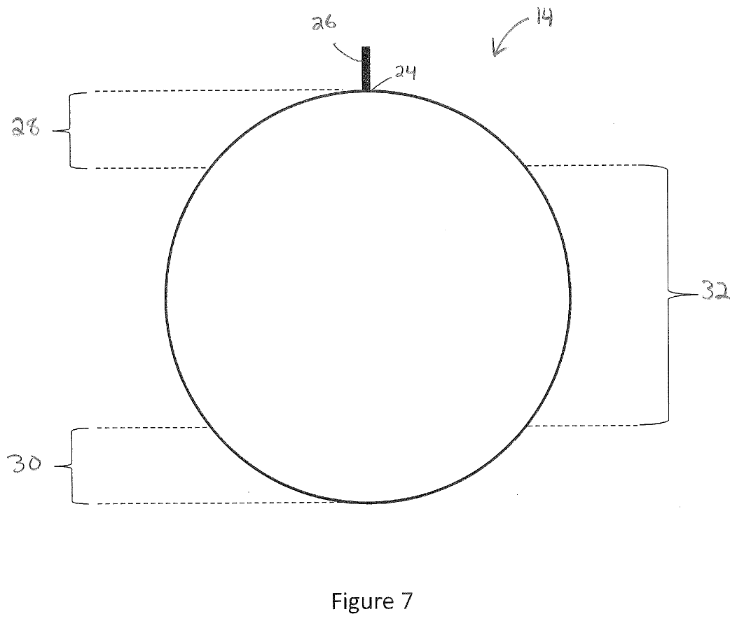

FIG. 7 illustrates an inflated inflatable support 14 without the covering 12. The inflatable support 14 comprises a general ball or spherical shape having a hollow configuration due to its inflatable nature. The inflatable support 14 includes a top end (or top spherical cap) 28, a bottom end (or bottom spherical cap) 30, and a central portion (or central spherical segment) 32. Additionally, in some embodiments the plug 26 can also be configured as an attachment portion for the inflatable assembly.

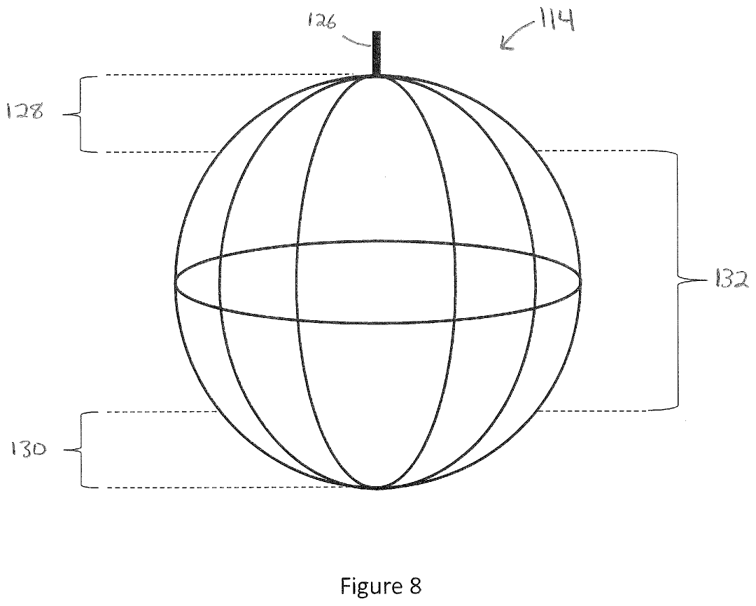

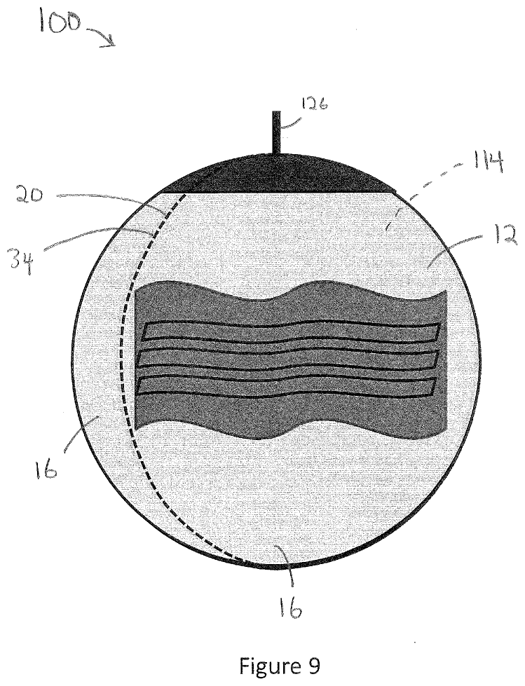

While various exemplary embodiments have been described in connection with an inflatable support, one skilled in the art will appreciate that the various embodiments are not necessarily so limited and that other embodiments may comprise support members having different configurations. For example, referring now to FIG. 8, there is shown another embodiment of a support member 114 (used in the display assembly 100 shown in FIG. 9). The support member 114 is similar to the inflatable support member 14 and similarly comprises a general ball or spherical shape having a hollow configuration. However in this embodiment, instead of an inflatable configuration the support member comprises a general spherical cage-like configuration. Similar to the support member 14, the support member (or skeleton) 114 has a top end (or top spherical cap) 128, a bottom end (or bottom spherical cap) 130, and a central portion (or central spherical segment) 132. Additionally, an attachment portion 126 can be provided for the display assembly 100. The cage-like member 114 can be an integral one-piece member fabricated from a hard plastic material or a fiberglass material, however in alternate embodiments the cage-like member 114 can be fabricated from any suitable lightweight and substantially rigid material capable of maintaining a substantially spherical shape when the removable covering is fitted thereon. Although FIG. 8 illustrates the support member 114 as having portions of the support member extending along longitudinal and latitudinal directions of the support member, any other suitable configuration may be provided. For example, some embodiments of the support member may comprise a spherical shape having various relief openings of any suitable size or shape, in other embodiments the support member may have a spherical shape without any openings.

Similar to the display assembly 10, the display assembly 100 is configured to have the removable covering 12 fitted over the support member 114. In this embodiment, the removable covering 12 comprises a fastener 34 (such as a zipper or a hook and loop fastener, for example) at one or more of the seams 20. Having a fastener at one or more of the seams is preferred in this configuration as the substantially rigid body 114 is not deflateable and the ability to have a fastener to separate and reattach the panels provides a robust, reliable and cost effective means of removing and replacing the covering 12.

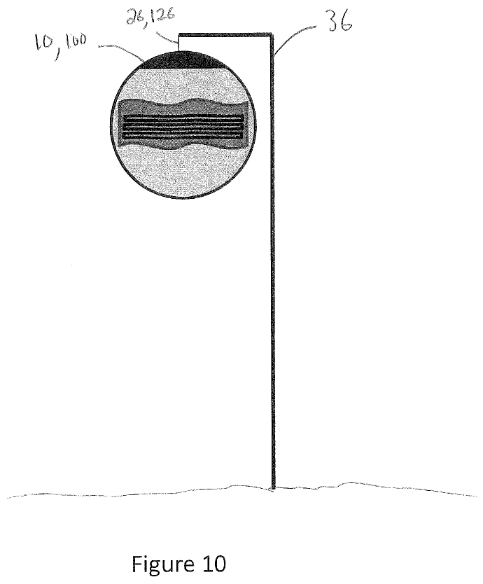

According to various exemplary embodiments, the display assembly 10, 100 may be attached to an existing structure (such as a ceiling, or wall fixture, for example) so as to hang from above. However it should be understood that the display assembly may be attached to any suitable mounting area. For example, and referring now also to FIG. 10, the display assembly may be displayed such that the attachment portion 26, 126 of the display assembly 10, 100 is coupled to a pole (or fiberglass rod) 36. In other instances, the display assembly 10, 100 may be secured so as to rest on the ground, floor, or any other location.

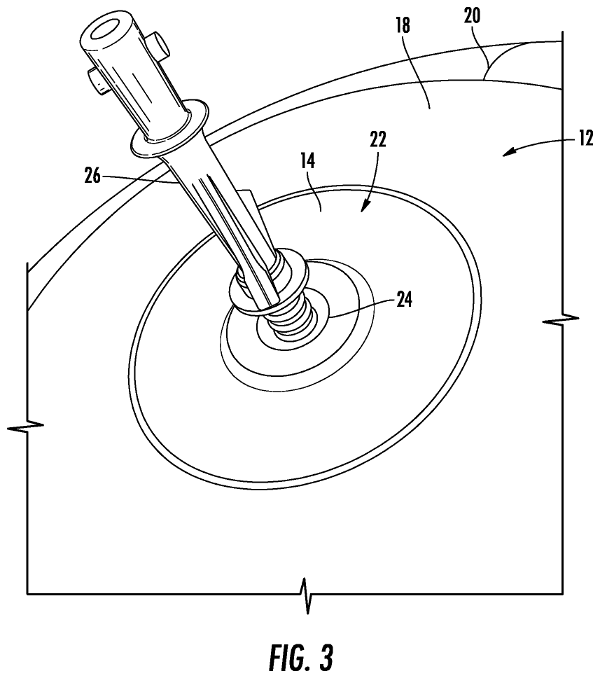

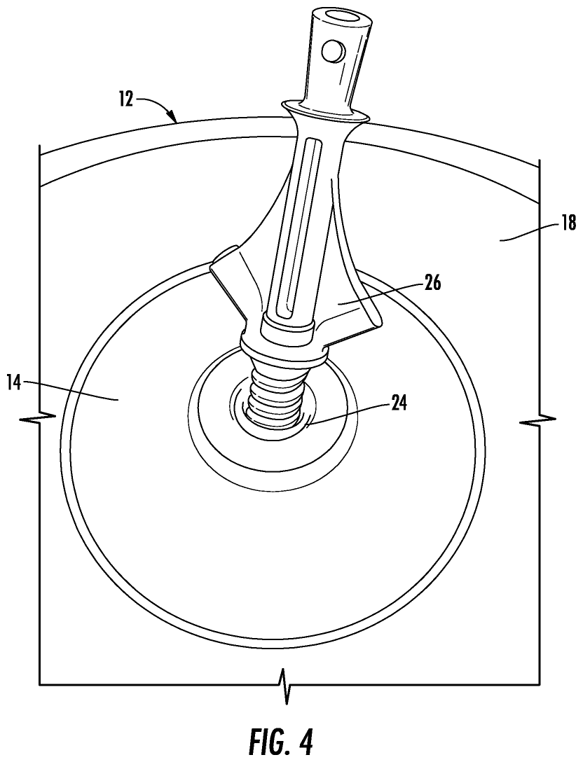

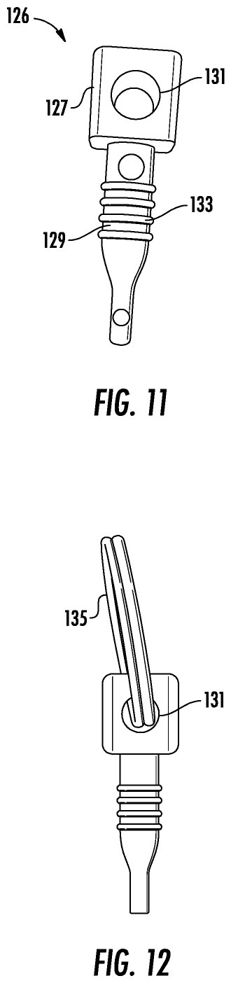

Various exemplary embodiments above have been described with the plug 26 (best shown in FIGS. 3, 4) inserted in the fill hole 24. It should be noted that other embodiments may comprise a plug having different configurations. For example, referring now to FIG. 11, there is shown another embodiment of a plug 126 (used in the display assembly 10). The plug 126 is similar to the plug 26, however in this embodiment the plug 126 comprises a more compact and lower profile configuration than the plug 26. The plug 126 comprises an attachment section 127 and a plug section 129. The attachment section 127 comprises an opening 131 suitably sized and shaped to allow attachment of the assembly to a desired structure or member. The plug section 129 (which may comprise rib features 133) is suitably sized and shaped to be inserted in the fill hole 24 so as to maintain the inflatable support 14 in an inflated state. Various exemplary embodiments may further comprise the plug with a ring 135 (which may be a key ring, for example) extending through the opening 131 for facilitating attachment to a structure or member (see FIG. 12). Additionally, in other embodiments any suitable type of plug may be provided.

Technical effects of any one or more of the exemplary embodiments provide significant advantages when compared to conventional configurations (such as helium filled balloons, for example). Various exemplary embodiments provide a reusable configuration that is easily interchanged with different removable coverings. Various embodiments also provide improvements in maintaining the aesthetics of the display assembly in varying environmental conditions. For example, helium filled balloons may slightly deflate due to temperature changes (which can lead to improperly displayed messages or graphics), however various embodiments (such as those comprising the cage-like support 114) are less susceptible to these changes and therefore maintain the desired aesthetics of the display assembly. These embodiments are configured to maintain a snug fit of the removable covering over the support member without a gap therebetween.

Below are provided further descriptions of various non-limiting, exemplary embodiments. The below-described exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, a display assembly comprising: a hollow support member comprising a substantially spherical shape having a top end, a bottom end, and a central portion between the top end and the bottom end, wherein the top end comprises an attachment portion; and a removable covering comprising a first end and an opening opposite the first end, wherein the removable covering is configured to have a corresponding spherical shape when fitted over the hollow support member, wherein the opening is configured to be aligned with the top end of the hollow support member such that the attachment portion is accessible, wherein the removable covering comprises a plurality of first panels, and wherein the removable covering comprises a graphic or message extending across the plurality of first panels.

A display assembly as above, wherein the hollow support member comprises an inflatable member.

A display assembly as above, wherein the inflatable member comprises a polymeric material.

A display assembly as above, wherein the hollow support member comprises a substantially rigid frame member.

A display assembly as above, wherein the substantially rigid frame member comprises a plastic or fiberglass material.

A display assembly as above, wherein the removable covering comprises a second panel connected to the plurality of first panels, wherein the first end comprises a closed end, and wherein the second panel comprises the opening.

A display assembly as above, wherein the plurality of first panels are joined to one another at seams between the plurality of first panels.

A display assembly as above, wherein at least one of the seams comprises a fastener configured to allow the at least one of the seams to be opened for access to an interior of the removable covering.

A display assembly as above, wherein the fastener comprises a zipper or a hook and loop fastener.

A display assembly as above, wherein the graphic or message extending across the plurality of first panels comprises lettering.

In another exemplary embodiment, a display assembly comprising: a hollow support member comprising a top spherical cap, a bottom spherical cap, and a central spherical segment between the top spherical cap and the bottom spherical cap; and a removable covering comprising a closed end and an opening opposite the closed end, wherein the opening is configured to be aligned with the top spherical cap of the hollow support member, wherein the removable covering is configured to be fitted over the hollow support member such that the closed end follows a spherical profile shape of the bottom spherical cap of the hollow support member, wherein the removable covering comprises a plurality of first panels, and wherein the removable covering comprises a graphic or message extending across the plurality of first panels.

A display assembly as above, wherein the hollow support member comprises an inflatable member.

A display assembly as above, wherein the inflatable member comprises a polymeric material.

A display assembly as above, wherein the hollow support member comprises a substantially rigid frame member.

A display assembly as above, wherein the substantially rigid frame member comprises a plastic or fiberglass material.

A display assembly as above, wherein the removable covering is configured to be fitted over the hollow support member such that the closed end contacts at least a majority of an outer surface of the bottom spherical cap of the hollow support member.

In another exemplary embodiment, a method comprising: providing a hollow support member, wherein the hollow support member comprises a substantially spherical shape having a top end, a bottom end, and a central portion between the top end and the bottom end, wherein the top end comprises an attachment portion; and providing a first removable covering, wherein the first removable covering comprises a closed end and an opening opposite the closed end, wherein the first removable covering comprises a plurality of panels, and wherein the first removable covering comprises a graphic or message extending across the plurality of panels; fitting the first removable covering over the hollow support member, wherein the first removable covering is configured to have a corresponding spherical shape when fitted over the hollow support member; and aligning the opening with the top end of the hollow support member such that the attachment portion is accessible.

A method as above, further comprising: removing the first removable covering over the hollow support member; providing a second removable covering, wherein the second removable covering comprises a closed end and an opening opposite the closed end, wherein the second removable covering comprises a plurality of panels, and wherein the second removable covering comprises a graphic or message extending across the plurality of panels; fitting the second removable covering over the hollow support member, wherein the second removable covering is configured to have a corresponding spherical shape when fitted over the hollow support member; and aligning the opening of the second removable covering with the top end of the hollow support member such that the attachment portion is accessible.

A method as above, wherein removing the first removable covering comprises deflating the hollow support member so as to allow removal of the hollow support member from an interior of the first removable covering.

A method as above, wherein removing the first removable covering comprises separating a fastener at seams of one of the plurality of panels to allow removal of the hollow support member from an interior of the first removable covering.

It should be understood that components of the invention can be operationally coupled or connected and that any number or combination of intervening elements can exist (including no intervening elements). The connections can be direct or indirect and additionally there can merely be a functional relationship between components.

Although the disclosure presents various exemplary embodiments, it should be understood that the invention can be embodied in many alternate forms of embodiments. In addition, any suitable size, shape or type of elements or materials could be used.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

1. A display assembly comprising:
a hollow support member comprising a substantially spherical shape having a top end, a bottom end, and a central portion between the top end and the bottom end, wherein the top end comprises an attachment portion; and
a removable covering comprising a first end and an opening opposite the first end, wherein the removable covering is configured to have a corresponding spherical shape when fitted over the hollow support member, wherein the opening is configured to be aligned with the top end of the hollow support member such that the attachment portion is accessible, wherein the removable covering comprises a plurality of first panels, and wherein the removable covering comprises a graphic or message extending across the plurality of first panels.

2. The display assembly of claim 1 wherein the hollow support member comprises an inflatable member.

3. The display assembly of claim 2 wherein the inflatable member comprises a polymeric material.

4. The display assembly of claim 1 wherein the hollow support member comprises a substantially rigid frame member.

5. The display assembly of claim 4 wherein the substantially rigid frame member comprises a plastic or fiberglass material.

6. The display assembly of claim 1 wherein the removable covering comprises a second panel connected to the plurality of first panels, wherein the first end comprises a closed end, and wherein the second panel comprises the opening.

7. The display assembly of claim 1 wherein the plurality of first panels are joined to one another at seams between the plurality of first panels.

8. The display assembly of claim 7 wherein at least one of the seams comprises a fastener configured to allow the at least one of the seams to be opened for access to an interior of the removable covering.

9. The display assembly of claim 8 wherein the fastener comprises a zipper or a hook and loop fastener.

10. The display assembly of claim 1 wherein the graphic or message extending across the plurality of first panels comprises lettering.

11. A display assembly comprising:
a hollow support member comprising a top spherical cap, a bottom spherical cap, and a central spherical segment between the top spherical cap and the bottom spherical cap; and
a removable covering comprising a closed end and an opening opposite the closed end, wherein the opening is configured to be aligned with the top spherical cap of the hollow support member, wherein the removable covering is configured to be fitted over the hollow support member such that the closed end follows a spherical profile shape of the bottom spherical cap of the hollow support member, wherein the removable covering comprises a plurality of first panels, and wherein the removable covering comprises a graphic or message extending across the plurality of first panels.

12. The display assembly of claim 11 wherein the hollow support member comprises an inflatable member.

13. The display assembly of claim 12 wherein the inflatable member comprises a polymeric material.

14. The display assembly of claim 11 wherein the hollow support member comprises a substantially rigid frame member.

15. The display assembly of claim 14 wherein the substantially rigid frame member comprises a plastic or fiberglass material.

16. The display assembly of claim 11 wherein the removable covering is configured to be fitted over the hollow support member such that the closed end contacts at least a majority of an outer surface of the bottom spherical cap of the hollow support member.

17. A method comprising:
providing a hollow support member, wherein the hollow support member comprises a substantially spherical shape having a top end, a bottom end, and a central portion between the top end and the bottom end, wherein the top end comprises an attachment portion; and
providing a first removable covering, wherein the first removable covering comprises a closed end and an opening opposite the closed end, wherein the first removable covering comprises a plurality of panels, and wherein the first removable covering comprises a graphic or message extending across the plurality of panels;
fitting the first removable covering over the hollow support member, wherein the first removable covering is configured to have a corresponding spherical shape when fitted over the hollow support member; and
aligning the opening with the top end of the hollow support member such that the attachment portion is accessible.

18. The method of claim 17, further comprising:
removing the first removable covering over the hollow support member;
providing a second removable covering, wherein the second removable covering comprises a closed end and an opening opposite the closed end, wherein the second removable covering comprises a plurality of panels, and wherein the second removable covering comprises a graphic or message extending across the plurality of panels;
fitting the second removable covering over the hollow support member, wherein the second removable covering is configured to have a corresponding spherical shape when fitted over the hollow support member; and
aligning the opening of the second removable covering with the top end of the hollow support member such that the attachment portion is accessible.

19. The method of claim 18 wherein removing the first removable covering comprises deflating the hollow support member so as to allow removal of the hollow support member from an interior of the first removable covering.

20. The method of claim 18 wherein removing the first removable covering comprises separating a fastener at seams of one of the plurality of panels to allow removal of the hollow support member from an interior of the first removable covering.
